(19) United States
(12) Patent Application Publication
(10) Pub. No.: US 2025/0045065 A1
(43) Pub. Date: Feb. 6, 2025

(54) HARDWARE PARAMETER SETTING METHOD AND ELECTRONIC DEVICE

(71) Applicant: Acer Incorporated, New Taipei City (TW)

(72) Inventors: Yu-Shan Ruan, New Taipei City (TW); Liang-Chi Chen, New Taipei City (TW)

(73) Assignee: Acer Incorporated, New Taipei City (TW)

(21) Appl. No.: 18/786,620

(22) Filed: Jul. 29, 2024

(30) Foreign Application Priority Data
Jul. 31, 2023 (TW) 112128604

(51) Int. Cl. G06F 9/445; G06F 8/71

(52) U.S. Cl. CPC G06F 9/44505; G06F 8/71

(57) ABSTRACT

A hardware parameter setting method and an electronic device are provided. The method includes following steps. A hardware start event which reflects that target hardware equipment is in a startup status is detected. In response to the hardware start event, a hardware parameter setting interface presenting at least one parameter setting item associated with the target hardware equipment is presented on a display. A user operation corresponding to the hardware parameter setting interface is received. In response to the user operation, parameter setting information is provided to a hardware control interface corresponding to the target hardware equipment. A parameter setting is performed on the target hardware equipment through the hardware control interface.

### CROSS-REFERENCE TO RELATED APPLICATION

This application claims the priority benefit of Taiwan patent application serial no. 112128604, filed on Jul. 31, 2023. The entirety of the above-mentioned patent application is hereby incorporated by reference herein and made a part of this specification.

### BACKGROUND

### Technical Field

The disclosure relates to a device control technology and particularly relates to a hardware parameter setting method and an electronic device.

### Description of Related Art

Conventionally, whenever an electronic device, such as a laptop or desktop computer, is connected to a hardware device (for instance, a camcorder, a microphone, or a speaker), an installation program of the electronic device assists users in downloading and installing drivers and operation programs associated with the hardware device. When the need arises to modify parameters associated with this particular hardware device, the users are faced with the cumbersome task of navigating through various folders within the operating system of the electronic device to locate the dedicated operation program designed to control the hardware device. This process is not particularly user-friendly. Besides, the designs and/or the operational logics of these operation programs differ across various types of hardware devices and suppliers, which adds to the complexity of adjusting parameters for hardware devices, thereby posing challenges for users during the parameter-setting process.

### SUMMARY

The disclosure provides a hardware parameter setting method and an electronic device, which are capable of improving an operational efficiency of setting parameters for hardware devices.

An embodiment of the disclosure provides a hardware parameter setting method which may be configured to perform a parameter setting on at least one hardware equipment of an electronic device. The hardware parameter setting method includes following steps. A hardware start event is detected, where the hardware start event reflects that target hardware equipment in the at least one hardware equipment is in a startup status. In response to the hardware start event, a hardware parameter setting interface is presented on a display, where the hardware parameter setting interface presents at least one parameter setting item associated with the target hardware equipment. A user operation corresponding to the hardware parameter setting interface is received. In response to the user operation, at least one parameter setting information is provided to a hardware control interface corresponding to the target hardware equipment. The parameter setting is performed on the target hardware equipment through the hardware control interface.

Another embodiment of the disclosure provides an electronic device that includes a display, at least one interface circuit, and a processor. The at least one interface circuit is configured to be coupled to at least one hardware equipment. The processor is coupled to the display and the at least one interface circuit. The processor is configured to detect a hardware start event, where the hardware start event reflects target hardware equipment in the at least one hardware equipment is in a startup status. In response to the hardware start event, the processor is configured to present a hardware parameter setting interface on the display, where the hardware parameter setting interface presents at least one parameter setting item associated with the target hardware equipment. The processor is configured to receive a user operation corresponding to the hardware parameter setting interface. In response to the user operation, the processor is configured to provide at least one parameter setting information to a hardware control interface corresponding to the target hardware equipment. The processor is configured to perform parameter setting on the target hardware equipment through the hardware control interface.

In view of the above, when the hardware start event is detected, one hardware parameter setting interface may be presented on the display, and in the hardware parameter setting interface, at least one parameter setting item associated with the target hardware equipment in the startup status may be presented. Upon receiving the user operation corresponding to the hardware parameter setting interface, in response to the user operation, at least one parameter setting information may be provided to the hardware control interface corresponding to the target hardware equipment, so as to allow the hardware control interface to perform parameter setting on the target hardware equipment. This approach effectively enhances the operational efficiency of parameter setting on the target hardware equipment while the target hardware equipment is in its startup status.

To make the above more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an electronic device according to an embodiment of the disclosure.

FIG. 2 is a system architecture diagram according to an embodiment of the disclosure.

FIG. 3 is a flowchart of a hardware parameter setting method according to an embodiment of the disclosure.

FIG. 4 is a flowchart of a hardware parameter setting method according to an embodiment of the disclosure.

### DESCRIPTION OF THE EMBODIMENTS

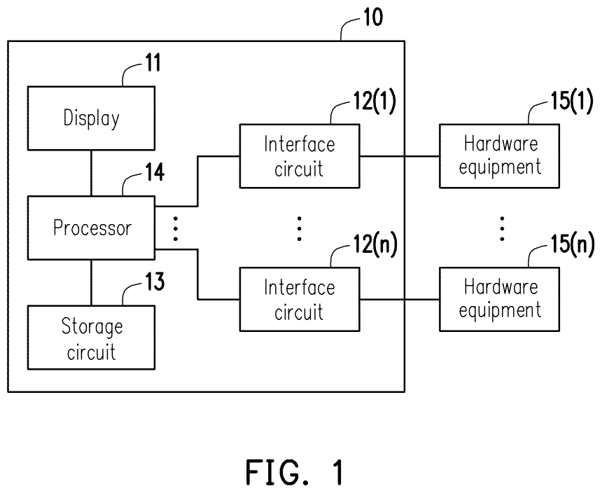

FIG. 1 is a schematic diagram of an electronic device according to an embodiment of the disclosure. With reference to FIG. 1, an electronic device 10 may include various types of computer devices, such as a smartphone, a tablet, a laptop computer, a desktop computer, an industrial computer, a vehicle-mounted computer, a server, or a game console, and the type of electronic device 10 is not limited to what is described above. The electronic device 10 may be coupled to hardware equipment 15(1)-15(n) to use the functions provided by the hardware equipment 15(1)-15(n).

The electronic device 10 includes a display 11, interface circuits 12(1)-12(n), a storage circuit 13, and a processor 14. The display 11 is configured to display images. For instance, the display 11 may include a plasma display, a liquid crystal display (LCD), a thin-film transistor (TFT) LCD, a light emitting diode (LED) LCD, an organic LED display, or any other type of displays, and the type of the display 11 is not limited to what is described above.

The interface circuits 12(1)-12(n) are configured to be coupled to the hardware devices 15(1)-15(n). The number of the interface circuits 12(1)-12(n) may be one or plural. The interface circuit 12(i) is configured to be coupled to the hardware device 15(i), i ranges from 1 to n, and n may be any positive integer. For instance, the interface circuit 12(i) may be configured to transmit signals between the processor 14 and the hardware device 15(i). The interface circuits 12(1)-12(n) may comply with various wired or wireless communication standards, such as a universal serial bus (USB) standard, Bluetooth, Bluetooth low energy (BLE), and/or WiFi, for instance.

The storage circuit 13 is configured to store data. For instance, the storage circuit 13 may include a volatile storage circuit and a non-volatile storage circuit. The volatile storage circuit is configured to store data in a volatile manner. For instance, the volatile storage circuit may include a random access memory (RAM) or another similar volatile storage medium. The non-volatile storage circuit is configured to store data in a non-volatile manner. For instance, the non-volatile storage circuit may include a read only memory (ROM), a solid state disk (SSD), a hard disk drive (HDD), or another similar non-volatile storage medium.

The processor 14 is coupled to the display 11, the interface circuits 12(1)-12(n), and the storage circuit 13. The processor 14 may be responsible for the overall or partial operation of the electronic device 10. For instance, the processor 14 may be a central processing unit (CPU), a graphics processing unit (GPU), or any other programmable general-purpose or special-purpose microprocessor, digital signal processor (DSP), programmable controller, application specific integrated circuit (ASIC), programmable logic device (PLD), another similar device, or a combination of these devices.

The hardware equipment 15(1)-15(n) may serve as at least some of input/output (I/O) devices of the electronic device 10. For instance, the hardware equipment 15(1)-15(n) may include various I/O devices, such as camcorders, microphones, speakers, mice, keyboards, and/or touchpads, and the types of the hardware equipment 15(1)-15(n) are not limited to those described above. In addition, the number of the hardware equipment 15(1)-15(n) may be one or plural.

In an embodiment of the disclosure, the storage circuit 13 may store one or more operating systems. For instance, the storage circuit 13 may store Windows, iOS, and/or Chrome OS, and the types of the operating systems are not limited to those described above. The processor 14 may run the operating system in the storage circuit 13 to control the electronic device 10 to perform the functions required by the user. For instance, during the process of running the operating system, the processor 14 may execute signal input and/or output by the hardware equipment 15(1)-15(n). In addition, during the process of running the operating system, the processor 14 may perform parameter setting on at least one of the hardware equipment 15(1)-15(n) according to a user operation, so as to adjust the functional effects of the hardware equipment 15(1)-15(n).

In an embodiment of the disclosure, the processor 14 may detect a hardware start event. The hardware start event may reflect that target hardware equipment (e.g., the hardware equipment 15(i)) is in a startup (ON) status. For instance, when the target hardware equipment is started, the processor 14 may detect the hardware start event corresponding to the target hardware equipment. In an embodiment of the disclosure, the processor 14 may also detect a hardware shutdown event. The hardware shutdown event may reflect the target hardware equipment is in a shutdown (OFF) status (i.e., not in a startup status). For instance, when the target hardware equipment is shut down, the processor 14 may detect the hardware shutdown event corresponding to the target hardware equipment.

In an embodiment of the disclosure, in response to the hardware start event, the processor 14 may present a hardware parameter setting interface on the display 11. Specifically, the hardware parameter setting interface presents at least one parameter setting item associated with the target hardware equipment. One parameter setting item may be configured to adjust (e.g., initiate or discontinue) one functional effect supported by the target hardware equipment.

In an embodiment of the disclosure, assuming the target hardware equipment is a camcorder, the parameter setting items presented in the hardware parameter setting interface may be configured to adjust (e.g., initiate or discontinue) functional effects supported by the target hardware equipment (i.e., the camcorder), such as high dynamic range (HDR), auto framing, eye contact, background blur, and/or 3D scene, and the functional effects that may be adjusted by the presented parameter setting items are not limited to those described above. Alternatively, in an embodiment of the disclosure, assuming the target hardware equipment is a speaker, the parameter setting items presented in the hardware parameter setting interface may be configured to adjust (e.g., initiate or discontinue) functional effects supported by the target hardware equipment (i.e., the speaker), such as surround sound field, active noise cancellation, and/or subwoofer, and the functional effects that may be adjusted by the presented parameter setting items are not limited to those described above. By analogy, according to the type of the target hardware equipment, the parameter setting items presented in the hardware parameter setting interface may be adjusted correspondingly to meet the setting requirements of the user for the functional effects supported by the target hardware equipment.

In an embodiment of the disclosure, during the display of the hardware parameter setting interface on the display 11, the processor 14 may receive a user operation corresponding to the hardware parameter setting interface. For instance, the user operation may indicate an adjustment of setting values of at least some of the parameter setting items in the hardware parameter setting interface. For instance, when the target hardware equipment is a camcorder, the user operation may be performed to adjust (e.g., initiate or discontinue) the functional effects supported by the target hardware equipment (i.e., the camcorder) through the hardware parameter setting interface, such as HDR, auto framing, eye contact, background blur, and/or 3D scene. Alternatively, when the target hardware equipment is a speaker, the user operation may be performed to adjust (e.g., initiate or discontinue) the functional effects supported by the target hardware equipment (i.e., the speaker) through the hardware parameter setting interface, such as surround sound field, active noise cancellation, and/or subwoofer.

In an embodiment of the disclosure, in response to the user operation, the processor 14 may provide at least one parameter setting information to a hardware control interface corresponding to the target hardware equipment. For instance, the hardware control interface may include an application programming interface (API) responsible for communicating with the target hardware equipment. The parameter setting information may, for instance, carry information about setting or adjustment of at least some of the functional effects supported by the target hardware equipment according to the user operation. The hardware control interface may then perform parameter setting on the target hardware equipment according to the parameter setting information. For instance, based on the parameter setting information, the hardware control interface may modify at least some of the parameters associated with the target hardware equipment to adjust (e.g., initiate or discontinue) at least some of the functional effects supported by the target hardware equipment.

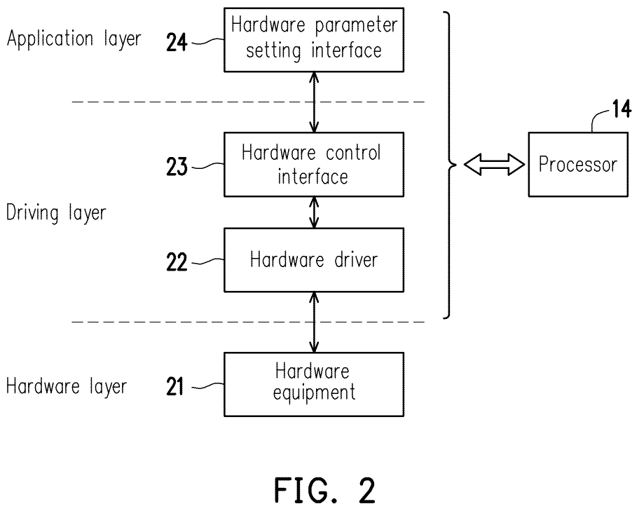

FIG. 2 is a system architecture diagram according to an embodiment of the disclosure. With reference to FIG. 1 and FIG. 2, it is assumed that the target hardware equipment is hardware equipment 21. The hardware equipment 21 is located in a hardware layer. A hardware driver 22 and a hardware control interface 23 are located in a driving layer. A hardware parameter setting interface 24 is located in an application layer.

In an embodiment of the disclosure, the processor 14 may detect a hardware start event corresponding to the hardware equipment 21 through the hardware driver 22. In response to the hardware start event, the processor 14 may enable a hardware parameter setting interface 24. After enabling the hardware parameter setting interface 24, the processor 14 may receive a user operation corresponding to the hardware parameter setting interface 24 through the I/O device. In response to the user operation, the processor 14 may provide the parameter setting information corresponding to the hardware equipment 21 to the hardware control interface 23. For instance, the hardware control interface 23 may include an API responsible for communicating with the hardware equipment 21. According to the parameter setting information, the hardware control interface 23 may perform the parameter setting on the hardware equipment 21 to adjust (e.g., initiate or discontinue) at least some of the functional effects supported by the hardware equipment 21.

In an embodiment of the disclosure, in response to the hardware start event, the processor 14 may obtain an effect list corresponding to the target hardware equipment (e.g., the hardware equipment 21). For instance, the effect list may carry information about at least one functional effect that the target hardware equipment may support. According to the effect list, the processor 14 may present at least one parameter setting item in the hardware parameter setting interface 24. Each parameter setting item may correspond to one functional effect supported by the target hardware equipment.

In an embodiment of the disclosure, the effect list may be recorded in a specific data format (e.g., a JSON data format). For instance, the effect list may record names and setting values of one or more functional effects that the target hardware equipment may support. A camcorder that supports HDR, auto framing, eye contact, background blur, and 3D scene is taken as an example of the target hardware equipment, and the effect list may record {“HDR”: “ON”, “HDR”: “OFF”, “AutoFraming”: “ON”, “AutoFraming”: “OFF”, “EyeContact”: “ON”, “EyeContact”: “OFF”, “BGBlur”: “ON”, “BGBlur”: “OFF”, “3DScene”: “ON”, “3DScene”: “OFF”} or similar contents.

In an embodiment of the disclosure, the processor 14 may download the effect list via a network API (a socket interface) from an external server. For instance, the effect list may be provided by a developer of the target hardware equipment, a supplier f the target hardware equipment, or a third party. The effect lists from different sources may be integrated (e.g., merged). For instance, in an embodiment of the disclosure, the effect list provided by the supplier of the target hardware equipment may carry information which the target hardware equipment may support, such as HDR, auto framing, eye contact, and background blur, while the effect list provided by the third party may carry information about a 3D scene that the target hardware equipment may support. The processor 14 may download the effect lists provided separately by the supplier of the target hardware equipment and the third party from the external server and integrate them into a single effect list. After that, the processor 14 may present the parameter setting items in the hardware parameter setting interface 24 according to the integrated effect list.

In an embodiment of the disclosure, after obtaining the effect list corresponding to the target hardware equipment, the processor 14 may set this effect list as a default effect list corresponding to the target hardware equipment. In an embodiment of the disclosure, in response to the hardware start event, the processor 14 may check whether a version of the default effect list corresponding to the target hardware equipment is the latest version. In response to the version of the default effect list not being the latest version, the processor 14 may download the latest version of the effect list corresponding to the target hardware equipment from an external server to update or replace this default effect list. Thereafter, the processor 14 may use the updated or replaced effect list to generate and present the parameter setting item in the hardware parameter setting interface 24. In addition, if the version of the default effect list is already the latest version, then the processor 14 may directly use this default effect list to generate and present the parameter setting item in the hardware parameter setting interface 24 in no need of re-downloading the effect list corresponding to the target hardware equipment.

In an embodiment of the disclosure, the parameter setting items corresponding to a plurality of target hardware equipment may be integrated into the same hardware parameter setting interface. For instance, it is assumed that the target hardware equipment includes a first target hardware equipment (e.g., the hardware equipment 15(i) in FIG. 1) and a second target hardware equipment (e.g., the hardware equipment 15(j) in FIG. 1), and i is not equal to j. The processor 14 may obtain at least one parameter setting item (also known as a first parameter setting item) associated with the first target hardware equipment according to the effect list (also known as a first effect list) corresponding to the first target hardware equipment. The processor 14 may obtain at least one parameter setting item (also known as a second parameter setting item) associated with the second target hardware equipment according to the effect list (also known as a second effect list) corresponding to the second target hardware equipment. After that, the processor 14 may integrate the first parameter setting item and the second parameter setting item into the same hardware parameter setting interface (e.g., the hardware parameter setting interface 24 in FIG. 2).

In an embodiment of the disclosure, in response to the first target hardware equipment and/or the second target hardware equipment being started, the processor 14 may present a hardware parameter setting interface synchronically presenting the first parameter setting item and the second parameter setting item on the display 11. Thereby, the user may perform parameter setting on the first target hardware equipment and/or the second target hardware equipment in the hardware parameter setting interface. Compared with the conventional method that allow the user to open the setting pages of different hardware equipment one by one to perform parameter setting, in an embodiment of the disclosure, the integrated hardware parameter setting interface is configured to perform parameter setting on different target hardware equipment, which may effectively improve the convenience of operation.

In an embodiment of the disclosure, after the hardware parameter setting interface is started, the processor 14 may set the hardware parameter setting interface to be displayed always on top in the display 11. For instance, the processor 14 may set the hardware parameter setting interface to float at the topmost layer of all windows. Thereby, during the execution of the functions provided by the target hardware equipment, the user may modify the parameters of the target hardware equipment through the hardware parameter setting interface at any time, so as to adjust (e.g., initiate or discontinue) at least some of the functional effects supported by the target hardware equipment, thus effectively improving the convenience of operation.

In an embodiment of the disclosure, the hardware parameter setting interface does not belong to a native control interface of the target hardware equipment. For instance, the native control interface of the target hardware equipment may be provided by the developer or the supplier of the target hardware equipment, so as to provide basic control over the target hardware equipment. However, compared to the hardware parameter setting interface, the content of the native control interface of the target hardware equipment is not updated in real time according to the effect list. Moreover, compared to the hardware parameter setting interface that may integrate the parameter setting items of different target hardware equipment, the native control interfaces of different target hardware equipment cannot be integrated into the same control interface. Therefore, compared to the native control interface of the target hardware equipment, using the hardware parameter setting interface to control the target hardware equipment may effectively improve the convenience of operation.

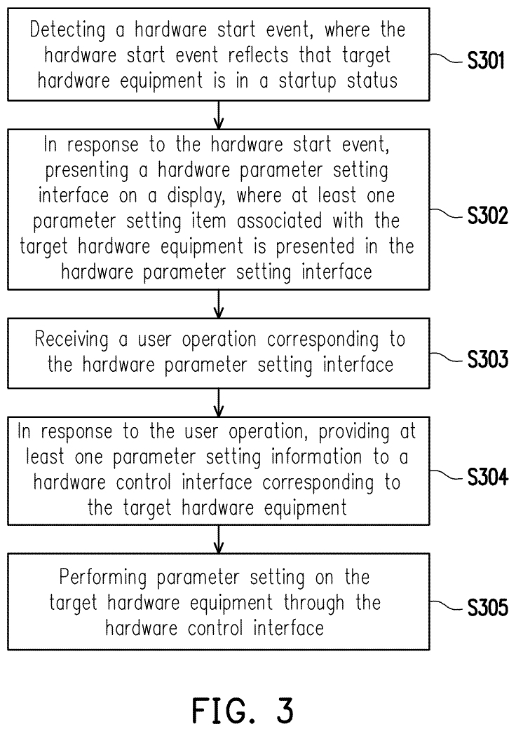

FIG. 3 is a flowchart of a hardware parameter setting method according to an embodiment of the disclosure. With reference to FIG. 3, in step S301, a hardware start event is detected, where the hardware start event reflects that target hardware equipment in at least one hardware device is in a startup status. In step S302, in response to the hardware start event, a hardware parameter setting interface is presented on a display, where at least one parameter setting item associated with the target hardware equipment is presented in the hardware parameter setting interface. In step S303, a user operation corresponding to the hardware parameter setting interface is received. In step S304, in response to the user operation, at least one parameter setting information is provided to a hardware control interface corresponding to the target hardware equipment. In step S305, parameter setting is performed on the target hardware equipment through the hardware control interface.

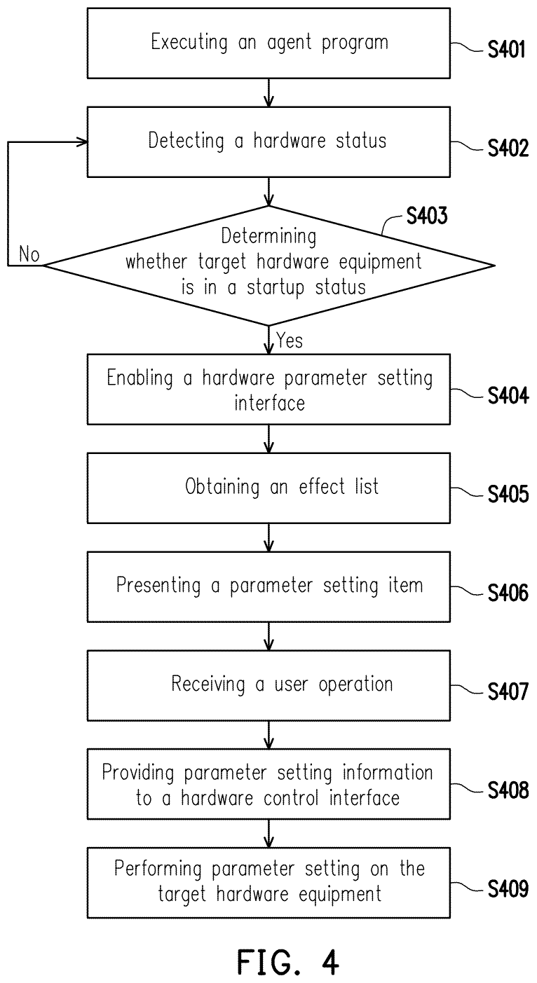

FIG. 4 is a flowchart of a hardware parameter setting method according to an embodiment of the disclosure. With reference to FIG. 4, in step S401, an agent program is executed. This agent program may include a plurality of program modules for executing the hardware parameter setting method. The processor 14 depicted in FIG. 1 may execute the hardware parameter setting method through this agent program. In step S402, a hardware status is detected. In step S403, it is determined whether the target hardware equipment is in a startup status. If the target hardware equipment is in the startup status, in step S404, in response to a hardware start event, the hardware parameter setting interface is enabled (or initiated). For instance, the enabled hardware parameter setting interface may be presented on the display 11 depicted in FIG. 1. However, if the target hardware equipment is not in the startup status, the steps S402 and S403 may be repeated.

In step S405, in response to the hardware start event, an effect list corresponding to the target hardware equipment is obtained. In step S406, a parameter setting item is presented in the hardware parameter setting interface according to the effect list. In step S407, a user operation corresponding to the hardware parameter setting interface is received. In step S408, based on this user operation, parameter setting information is provided to a hardware control interface corresponding to the target hardware equipment. In step S409, the hardware control interface performs parameter setting on the target hardware equipment to adjust (e.g., initiate or discontinue) at least some of the functional effects supported by the target hardware equipment.

The steps in FIG. 3 and FIG. 4 have been detailed above and will not be repeated hereinafter. Note that the steps in FIG. 3 and FIG. 4 may be implemented in form of programming codes or circuits, which should not be construed as limitations in the disclosure. In addition, the methods depicted in FIG. 3 and FIG. 4 may be applied with reference to other embodiments provided above or independently, which should not be construed as limitations in the disclosure.

To sum up, according to the hardware parameter setting method and in the electronic device provided in one or more embodiments of the disclosure, the hardware parameter setting interface may be presented dynamically based on the effect list corresponding to the target hardware equipment every time the target hardware equipment is initiated. Thereby, the users have the convenience of adjusting (initiating or discontinuing) at least some of the functional effects supported by the target hardware equipment through the hardware parameter setting interface when the target hardware equipment is in the startup status. Accordingly, the operational efficiency of performing the parameter setting on the target hardware equipment may be effectively improved.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A hardware parameter setting method, configured to perform a parameter setting on at least one hardware equipment of an electronic device and comprising:
detecting a hardware start event, wherein the hardware start event reflects target hardware equipment in the at least one hardware equipment is in a startup status;
in response to the hardware start event, presenting a hardware parameter setting interface on a display, wherein the hardware parameter setting interface presents at least one parameter setting item associated with the target hardware equipment;
receiving a user operation corresponding to the hardware parameter setting interface;
in response to the user operation, providing at least one parameter setting information to a hardware control interface corresponding to the target hardware equipment; and
performing the parameter setting on the target hardware equipment through the hardware control interface.

2. The hardware parameter setting method according to claim 1, wherein the step of presenting the hardware parameter setting interface on the display in response to the hardware start event comprises:
in response to the hardware start event, obtaining an effect list corresponding to the target hardware equipment; and
according to the effect list, presenting the at least one parameter setting item in the hardware parameter setting interface.

3. The hardware parameter setting method according to claim 2, wherein the step of obtaining the effect list corresponding to the target hardware equipment comprises:
downloading the effect list from an external server via a network application programming interface, wherein the effect list is provided by a developer of the target hardware equipment, a supplier of the target hardware equipment or a third party.

4. The hardware parameter setting method according to claim 2, wherein the step of obtaining the effect list corresponding to the target hardware equipment in response to the hardware start event comprises:
in response to the hardware start event, checking whether a version of a default effect list corresponding to the target hardware equipment is a latest version; and
in response to the version of the default effect list not being the latest version, downloading the latest version of the effect list from an external server to update or replace the default effect list.

5. The hardware parameter setting method according to claim 2, wherein the target hardware equipment comprises first target hardware equipment and second target hardware equipment, the effect list comprises a first effect list and a second effect list, the first effect list corresponds to the first target hardware equipment, the second effect list corresponds to the second target hardware equipment, and the step of presenting the at least one parameter setting item in the hardware parameter setting interface according to the effect list comprises:
obtaining at least one first parameter setting item associated with the first target hardware equipment according to the first effect list;
obtaining at least one second parameter setting item associated with the second target hardware equipment according to the second effect list; and
integrating the at least one first parameter setting item and the at least one second parameter setting item into the hardware parameter setting interface.

6. The hardware parameter setting method according to claim 1, wherein the step of presenting the hardware parameter setting interface on the display comprises:
setting the hardware parameter setting interface to be displayed always on top in the display.

7. The hardware parameter setting method according to claim 1, wherein the hardware parameter setting interface does not belong to a native control interface of the target hardware equipment.

8. An electronic device, comprising:
a display;
at least one interface circuit, configured to be coupled to at least one hardware equipment; and
a processor, coupled to the display and the at least one interface circuit, wherein the processor is configured to:
detect a hardware start event, wherein the hardware start event reflects target hardware equipment in the at least one hardware equipment is in a startup status;
in response to the hardware start event, present a hardware parameter setting interface on the display, wherein the hardware parameter setting interface presents at least one parameter setting item associated with the target hardware equipment;
receive a user operation corresponding to the hardware parameter setting interface;
in response to the user operation, provide at least one parameter setting information to a hardware control interface corresponding to the target hardware equipment; and
perform parameter setting on the target hardware equipment through the hardware control interface.

9. The electronic device according to claim 8, wherein the operation of the processor presenting the hardware parameter setting interface on the display in response to the hardware start event comprises:
in response to the hardware start event, obtaining an effect list corresponding to the target hardware equipment; and
according to the effect list, presenting the at least one parameter setting item in the hardware parameter setting interface.

10. The electronic device according to claim 9, wherein the operation of the processor obtaining the effect list corresponding to the target hardware equipment comprises:
downloading the effect list from an external server via a network application programming interface, wherein the effect list is provided by a developer of the target hardware equipment, a supplier of the target hardware equipment or a third party.

11. The electronic device according to claim 9, wherein the operation of the processor in response to the hardware start event to obtain the effect list corresponding to the target hardware equipment comprises:
in response to the hardware start event, checking whether a version of a default effect list corresponding to the target hardware equipment is a latest version; and
in response to the version of the default effect list not being the latest version, downloading the latest version of the effect list from an external server to update or replace the default effect list.

12. The electronic device according to claim 9, wherein the target hardware equipment comprises first target hardware equipment and second target hardware equipment, the effect list comprises a first effect list and a second effect list, the first effect list corresponds to the first target hardware equipment, the second effect list corresponds to the second target hardware equipment, and the operation of the processor presenting the at least one parameter setting item in the hardware parameter setting interface according to the effect list comprises:
obtaining at least one first parameter setting item associated with the first target hardware equipment according to the first effect list;
obtaining at least one second parameter setting item associated with the second target hardware equipment according to the second effect list; and
integrating the at least one first parameter setting item and the at least one second parameter setting item into the hardware parameter setting interface.

13. The electronic device according to claim 8, wherein the operation of the processor presenting the hardware parameter setting interface on the display comprises:
setting the hardware parameter setting interface to be displayed always on top in the display.

14. The electronic device according to claim 8, wherein the hardware parameter setting interface does not belong to a native control interface of the target hardware equipment.
